(19) United States
(12) Patent Application Publication
(10) Pub. No.: US 2007/0212576 A1
(43) Pub. Date: Sep. 13, 2007

(54) Magnetic recording medium with dual magnetic sides and having a low resistivity

(75) Inventors: Adam A. Brodd, Minneapolis, MN (US); Meng C. Hsieh, Woodbury, MN (US); Douglas W. Johnson, Stillwater, MN (US); Larold L. Olson, Lindstrom, MN (US)

Correspondence Address: Attention: Eric D. Levinson;Imation Corp., Legal Affairs, P.O. Box 64898, St. Paul, MN, 55164-0898, US

(73) Assignee: Imation Corp.

(21) Appl. No.: 11/370,404

(22) Filed: Mar. 8, 2006

(51) Int. Cl. G11B 5/716; B05D 5/12

(52) U.S. Cl. 428/839; 428/840.3; 427/127

(57) ABSTRACT

A magnetic recording medium for storing digital data includes a flexible substrate, a first magnetic side, and a second magnetic side. The flexible substrate defines a first surface and a second surface opposite the first surface. The first magnetic side has a resistivity of less than about 2×10⁶ ohms/square and includes a first support layer and a first magnetic layer. The first support layer is substantially non-magnetic and extends over the first surface of the substrate. The first magnetic recording layer extends over the first support layer opposite the substrate. The second magnetic side includes a second support layer and a second magnetic layer. The second support layer is substantially non-magnetic and extends over the second surface of the substrate. The second magnetic recording layer extends over the second support layer opposite the substrate.

### THE FIELD OF THE INVENTION

The present invention relates to magnetic recording media for storing data, such as magnetic recording tapes, including dual magnetic sides and exhibiting low resistivity on at least one of the magnetic sides.

### BACKGROUND OF THE INVENTION

Magnetic recording media, such as magnetic recording tapes and disks, enjoy wide use and popularity. As data storage on magnetic recording media evolves and its popularity continues, innovations increasing the capacity of the magnetic recording media while continuing to present a reliable magnetic recording media continue to be sought after.

In general terms, magnetic recording media generally comprise a magnetic layer coated over at least one side of a non-magnetic substrate (e.g., a film for magnetic recording tape applications). In certain designs, the magnetic coating is formed as a single layer directly onto the non-magnetic substrate. In an alternative approach, a dual-layer construction is employed, including a lower support layer on the substrate and a thin magnetic recording layer on the lower support layer. With this type of construction, the lower support layer is generally thicker than the magnetic layer. The support layer is typically non-magnetic and generally comprised of a non-magnetic powder dispersed in a binder. Conversely, the magnetic recording layer comprises one or more magnetic metal particle powders or pigments, such as pigments including particulate materials, such as ferromagnetic iron oxides, chromium oxides, ferromagnetic alloy powders and the like, dispersed in binder system and coated on a substrate. With this in mind, the magnetic recording layer defines a recording surface and is configured to record and store information.

Magnetic tapes typically also have a backside coating applied to the opposing side of the non-magnetic substrate in order to improve the durability, electro-conductivity, handling, and tracking characteristics of the media. The backside coatings are typically combined with a suitable solvent to create a homogeneous mixture which is then coated onto the substrate. The coated substrate is dried, calendered if desired, and cured. The formulation for the backside coating also comprises pigments in a binder system and is generally configured to lower the overall resistivity of the magnetic recording tape.

Forming a magnetic recording tape with only one magnetic side limits the recording density and data capacity of the magnetic recording tape. As such, there has been a desire to form a magnetic recording tape with dual magnetic sides. However, the absence of a backside generally increases the static discharge of the magnetic recording tape during use and attracts unwanted particles to the magnetic recording tape, thereby, decreasing the reliability and the life span of the resultant magnetic recording tape.

In addition, the two sides of the magnetic recording tape generally each have a different composition resulting in unwanted cupping and/or curling of the magnetic recording tape. Curling refers to the tendency of the magnetic recording tape to curl up upon itself lengthwise, while cupping causes the magnetic recording tape to curl in a lateral or transverse direction. As such, cupping and curling increase difficulties in handling the magnetic recording tape during manufacturing and may cause problems during use.

### SUMMARY OF THE INVENTION

One aspect of the present invention relates to a magnetic recording medium for storing digital data. The magnetic recording medium includes a flexible substrate, a first magnetic side, and a second magnetic side. The flexible substrate defines a first surface and a second surface opposite the first surface. The first magnetic side has a resistivity of less than about 2×10⁶ ohms/square and includes a first support layer and a first magnetic layer. The first support layer is substantially non-magnetic and extends over the first surface of the substrate. The first magnetic recording layer extends over the first support layer opposite the substrate. The second magnetic side includes a second support layer and a second magnetic layer. The second support layer is substantially non-magnetic and extends over the second surface of the substrate. The second magnetic recording layer extends over the second support layer opposite the substrate.

### BRIEF DESCRIPTION OF THE DRAWINGS

Embodiments of the invention are better understood with reference to the following drawings. The elements of the drawings are not necessarily to scale relative to each other. Like reference numerals designate corresponding similar parts.

FIG. 1 is a schematic illustration of a cross-sectional view of one embodiment of a magnetic recording medium.

FIG. 2 is a schematic illustration of one embodiment of a system for manufacturing the magnetic recording medium of FIG. 1.

FIG. 3 is a schematic illustration of one embodiment of a system for manufacturing the magnetic recording medium of FIG. 1.

FIG. 4 is a flow chart illustrating one embodiment of a method of manufacturing the magnetic recording medium of FIG. 1.

### DETAILED DESCRIPTION OF THE PREFERRED EMBODIMENTS

In the following detailed description, specific embodiments are described in which the invention may be practiced. It is to be understood that other embodiments may be utilized and structural or logical changes may be made without departing from the scope of the present invention. The following detailed description, therefore, describes certain embodiments and is not to be taken in a limiting sense. The scope of the present invention is defined by the appended claims.

Embodiments of magnetic recording media, such as magnetic recording tapes, including dual magnetic recording sides are disclosed herein to not only provide media with higher recording capacity as compared with a single magnetic side media, but to also provide at least one magnetic recording layer having a relatively low resistivity. In one embodiment, at least one magnetic side of the magnetic recording medium has a resistivity of less than about 2×10⁶ ohms/square. In one embodiment, at least one magnetic side of the magnetic recording medium has a resistivity of less than about 5×10⁵ ohms/square. The low resistivity values decrease static charge build up and the amount of debris attracted to the media during use of the magnetic recording media. Since static charge build up is decreased, any static built up on the magnetic recording media during use is substantially bled off of the magnetic recording media prior to passage of the magnetic recording media past a read/write head. As such, the embodiments of magnetic recording media described herein are provided with increased reliability and a longer life span than conventional magnetic recording media having dual magnetic recording sides.

In addition, some of the embodiments of magnetic recording media disclosed below include two magnetic recording sides each having a similar modulus such that the cupping of the magnetic recording media is between about 100 μm and about −100 μm. The low level of cupping described above increases the ease of handling the magnetic recording media during manufacture and subsequent use further contributes to the reliability and life span of the resulting magnetic recording media.

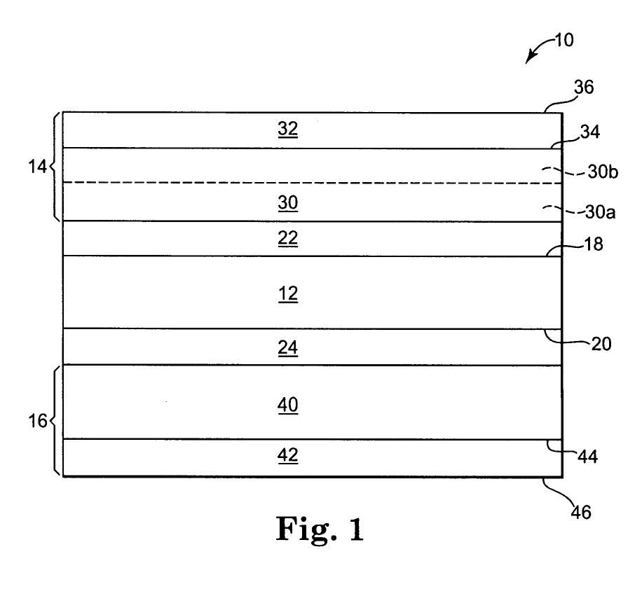

Turning to the figures, FIG. 1 illustrates a schematic, cross-sectional view of a magnetic recording medium 10, which more particularly is a magnetic recording tape. The magnetic recording tape 10 generally includes a substrate 12, a first magnetic side 14, and a second magnetic side 16. The substrate 12 defines a first or top surface 18 and a back or bottom surface 20 opposite top surface 18. In one embodiment, the first magnetic side 14 generally extends over the top surface 18 of the substrate 12, and the second magnetic side 16 generally extends over the bottom surface 20. The magnetic sides 14, 16 each provide recordable material to the magnetic recording tape 10. In one embodiment, the magnetic sides 14, 16 provide the magnetic recording tape 10 with a data storage capacity of greater than about 500 GB, preferably, greater than about 800 GB.

As used herein, a first component, such as a substrate, layer, side, etc., extending “over” a second component refers to the first component being layered or deposited across a surface on either side of the second component. As such, the term “over” does not refer to an orientation of either component or to a particular side of the second component, nor does “over” suggest direct interaction between the first and second components.

The Substrate

The substrate 12 is any non-magnetic substrate useful as a magnetic recording medium support. Examples of flexible substrate materials useful for the magnetic recording medium 10 include polyesters such as polyethylene terephthalate (PET), polyethylene naphthalate (PEN), a mixture of polyethylene terephthalate and polyethylene naphthalate; polyolefins (e.g., polypropylene); cellulose derivatives; polyamides; and polyimides. In one example, PET or PEN is preferably employed as the substrate 12. In general, the substrate 12 is in elongated tape form or is an elongated sheet configured to subsequently be cut into elongated tape form.

In one embodiment, one or more surfaces 18 and/or 20 of the substrate 12 are coated with any suitable primer 22 and/or 24, such as primers known in the art, to improve binding and adhesion of the corresponding magnetic side 14 or 16 with the substrate 12. The primer may be applied in any suitable method prior to application of the respective magnetic side 14 or 16.

The Magnetic Side

In one embodiment, the first magnetic side 14 includes a first support or lower layer 30 and a first magnetic recording or upper layer 32. The support layer 30 extends over the top surface 18 of the substrate 12. In one embodiment, the support layer 30 is, more specifically, bonded directly to a primer 22 extending over the top surface 18 of the substrate 12. In one embodiment, the support layer 30 is formed with one or more sublayers collectively defining the support layer 30. In other embodiments, the composition of the support layer 30 is substantially continuous throughout the support layer 30. The support layer 30 defines a top surface 34 opposite the substrate 12.

The magnetic layer 32 is configured to record and store data and extends over the top surface 34 of the support layer 30. In one embodiment, the composition of the magnetic layer 32 is substantially continuous throughout the magnetic layer 32. The magnetic layer 32 defines an outer or recording surface 36 opposite the support layer 30.

In one embodiment, the second magnetic side 16 is formed of dual-layer construction and includes a support or lower layer 40 and a magnetic recording or upper layer 42. The support layer 40 extends over the bottom surface 20 of the substrate 12. In one embodiment, the support layer 40 is, more specifically, bonded directly to a primer 24 extending over the bottom surface 20 of the substrate 12. In one embodiment, the support layer 40 is formed with one or more sublayers collectively defining the support layer 40. In other embodiments, the composition of the support layer 40 is substantially continuous throughout the support layer 40. The support layer 40 defines a surface 44 opposite the substrate 12.

The magnetic layer 42 is configured to record and store data and extends over the surface 44 of the support layer 40. In one embodiment, the composition of the magnetic layer 42 is substantially continuous throughout the magnetic layer 42. The magnetic layer 42 defines an outer or recording surface 46 opposite the support layer 40.

In other embodiments, one or both of the magnetic sides 14, 16 is formed of single layer construction in which the support layers 30, 40 are eliminated and the magnetic layers 32, 42 are bounded directly to the substrate 12, or more particularly, to the corresponding primer 22 or 24. In one embodiment, the magnetic sides 14, 16 are formed by any suitable combination of one or more layers that defines a recording surface 36 or 46 opposite the substrate 32. In one example, the magnetic sides 14, 16 are substantially similar to one another or are otherwise formed to each have a similar modulus. In forming the magnetic recording tape 10 with a similar modulus on each side of the substrate 12, cupping of the magnetic recording tape 10 can be limited. In one example, the magnetic recording tape exhibits cupping between about 100 μm and about −100 μm.

The Support Layers

The support layers 30, 40 are each substantially non-magnetic such that the support layer 30 or 40 does not substantially adversely affect the electromagnetic recording characteristics of the corresponding magnetic layer 32 or 42. In one embodiment, the support layer 30 is formed similarly or identical to the support layer 40. In other embodiments, the support layers 30, 40 differ in composition and/or application over the substrate 12. In one embodiment, each coated and processed support layer 30, 40 has a final thickness from about 20 microinches (0.5 μm) to about 50 microinches (1.25 μm).

In one embodiment, the composition making up each of the support layers 30, 40 includes at least a primary pigment material and conductive carbon black. The primary pigment material includes a substantially non-magnetic powder that is non-magnetic or a soft magnetic powder. As used herein, the term “soft magnetic powder” refers to a magnetic powder having a coercivity of less than about 23.9 kA/m (300 Oe). By forming one or both of the support layers 30, 40 to be substantially non-magnetic, the electromagnetic characteristics of the corresponding magnetic layer(s) 32, 42 are not substantially adversely affected. Therefore, to the extent that no substantially adverse effect is caused, the substantially non-magnetic support layers 30, 40 may contain a small amount of magnetic powder. In one embodiment, the primary pigment material includes particulate material, or “particles” selected from non-magnetic particulates, such as iron oxides, titanium dioxide, titanium monoxide, alumina, tin oxide, titanium carbide, silicon carbide, silicon dioxide, silicon nitride, boron nitride, etc., and soft magnetic particles. Optionally, these primary pigment materials are provided in a form coated with carbon, tin, or other electro-conductive material.

In one embodiment, the primary pigment material is formed of a non-magnetic α-iron oxide, which can be acidic or basic in nature. In one example, the non-magnetic α-iron oxides are substantially uniform in particle size, or are a metal starting material that is dehydrated by heating and annealed to reduce the number of pores. After annealing, the primary pigment material is ready for surface treatment, which is generally performed prior to mixing with other materials in the support layers 30, 40 (e.g., the carbon black, etc.). In one embodiment, the particle length of non-magnetic α-iron oxides or other primary pigment particles is less than 150 nm, preferably less than 120 nm. In one example, the α-iron oxides or other primary pigment particles are included in the support layers 30, 40 with a volume concentration of greater than about 35%, preferably greater than about 40%. α-iron oxides are well known and are commercially available from companies such as Dowa Mining Company Ltd. of Tokyo, Japan; Toda Kogyo Corp. of Hiroshima, Japan; and Sakai Chemical Industry Co. of Osaka, Japan.

The conductive carbon black material provides a certain level of conductivity so as to prohibit the respective magnetic layer 32, 42 from charging with static electricity and provides additional compressibility to the respective magnetic side 14, 16. As such, the respective magnetic side 14 and/or 16 is formed with a relatively low resistivity, preferably a resistivity less than 5×10¹⁰ ohms/square, more preferably a resistivity less than 2×10⁶ ohms/square, and even more preferably a resistivity less than 5×10⁵ ohms/square. In one example, the conductive carbon black is added in an amount no less than 5.5 parts of carbon black per 100 parts in unit weight of the primary pigment material of the support layer 30, 40. Experimental data shows that larger carbon particles with increased surface area are generally required in lesser quantities as compared to smaller carbon particles to lower the resistivity of the magnetic sides 14, 16 that will later be formed thereby. In one embodiment, using carbon black with a general size of about 1400 m²/g, the conductive carbon black is included in the support layer 30, 40 in an amount between about 4 and about 6 parts per 100 parts in unit weight of the primary pigment material. The milling of the dispersion used to form the support layer 30, 40 will also affect the resistivity as is further described below.

The support layers 30, 40 can also include additional pigment components such as an abrasive or head cleaning agent (HCA). In one embodiment, the head cleaning agent component is aluminum oxide. Other abrasive grains, such as silica, ZrO₂, Cr₂O₃, etc., can also be employed as at least part of the head cleaning agent.

In one embodiment, the binder system associated with the support layers 30, 40 incorporates at least one binder resin, such as a thermoplastic resin, in conjunction with other resin components such as binders and surfactants used to disperse the head cleaning agent, a surfactant (or wetting agent), and one or more hardeners. In one embodiment, the binder system of one or both of the support layers 30, 40 includes a combination of a primary polyurethane resin and a vinyl chloride resin, a vinyl chloride-vinyl acetate copolymer, vinyl chloride-vinyl acetate-vinyl alcohol copolymer, vinyl chloride-vinyl acetate-maleic anhydride, or the like.

In one embodiment, the vinyl resin is a nonhalogenated vinyl copolymer. Useful vinyl copolymers include copolymers of monomers comprising (meth)acrylonitrile; a nonhalogenated, hydroxyl functional vinyl monomer; a nonhalogenated vinyl monomer bearing a dispersing group, and one or more nonhalogenated nondispersing vinyl monomers. One example of a nonhalogenated vinyl copolymer is a copolymer of monomers comprising 5 to 40 parts by weight of methacrylonitrile, 30 to 80 parts by weight of one or more nonhalogenated, nondispersing, vinyl monomers, 5 to 30 parts by weight of a nonhalogenated hydroxyl functional, vinyl monomer, and 0.25 to 10 parts by weight of a nonhalogenated, vinyl monomer bearing a dispersing group.

Examples of useful polyurethanes include polyester-polyurethane, polyether-polyurethane, polycarbonate-polyurethane, polyester-polycarbonate-polyurethane, and polycaprolactone-polyurethane. Other resins such as bisphenol-A epoxide, styrene-acrylonitrile, and nitrocellulose are also acceptable for use in the support layer binder system.

In one embodiment, a primary polyurethane binder is incorporated into the support layer 30 in amounts from about 4 to about 10 parts by weight, and preferably from about 6 to about 8 parts by weight per 100 parts by weight of the primary pigment material. In one embodiment, the vinyl binder or vinyl chloride binder is incorporated into the support layer 30 in amounts from about 7 to about 15 parts by weight, and preferably from about 10 to about 12 parts by weight, based on 100 parts by weight of the primary pigment material.

In one embodiment, the binder system of the support layer 30 further includes a head cleaning agent binder used to disperse the selected head cleaning agent material, such as a polyurethane binder in conjunction with a pre-dispersed or paste head cleaning agent. Alternatively, other head cleaning agent binders compatible with the selected head cleaning agent format (e.g., a powder head cleaning agent) may be utilized.

The binder system may also contain a surface treatment agent. In one embodiment, the surface treatment agent is any suitable surface treatment agent, such as phenylphosphonic acid (PPA), 4-nitrobenzoic acid, and various other adducts of sulfuric, sulfonic, phosphoric, phosphonic, and carboxylic acids. In one embodiment, the binder system also contains a hardening agent such as isocyanate or polyisocyanate. In one example, the hardener component is incorporated into one or both of the support layers 30, 40 in amounts from about 2 to about 5 parts by weight, and preferably from about 3 to about 4 parts by weight, based on 100 parts by weight of the primary support layer pigment.

In one embodiment, one or both of the support layers 30, 40 further contains one or more lubricants such as a fatty acid and/or a fatty acid ester. The incorporated lubricant(s) exist throughout the corresponding magnetic sides 14, 16 and, importantly, at the recording surfaces 36, 46 of the magnetic layers 32, 42. The lubricant(s) reduces friction to maintain smooth contact with low drag, and protects the media surface from wear. Thus, in one example the lubricant(s) provided in both the support layer 30 and the magnetic layer 32 are selected and formulated in combination.

In one embodiment, one or both of the support layers 30, 40 includes stearic acid that is at least 90% pure as the fatty acid. Although technical grade acids and/or acid esters can also be employed for the lubricant component, incorporation of high purity lubricant materials generally ensures robust performance of the resultant medium. Alternatively, other acceptable fatty acids include myristic acid, palmitic acid, oleic acid, etc., and their mixtures. The formulation of the support layers 30, 40 can further include a fatty acid ester such as butyl stearate, isopropyl stearate, butyl oleate, butyl palmitate, butylmyristate, hexadecyl stearate, and oleyl oleate. The fatty acids and fatty acid esters may be employed singly or in combination. In one embodiment, the lubricant is incorporated into one or both of the support layers 30, 40 in an amount from about 1 to about 10 parts by weight, and preferably from about 1 to about 5 parts by weight per 100 parts by weight of the primary pigment material.

The materials for the support layers 30, 40 are mixed with the surface treated primary pigment, and the support layers 30, 40 are each coated to the substrate 12. In one embodiment, solvents are mixed with or otherwise associated with the support layers 30, 40 to form the coating material of the support layers 30, 40. In one example, the solvents include cyclohexanone (CHO) with a concentration in the range of about 5% and about 50%, methyl ethyl ketone (MEK) with a concentration in the range of about 30% and about 90%, and toluene (Tol) with a concentration in the range of about 0% and about 40%. Alternatively, other solvents or solvent combinations including, for example, xylene, tetrahydrofuran, methyl isobutyl ketone, and methyl amyl ketone, are associated with the coating material of the support layer 30.

The Magnetic Layers

In one embodiment, the magnetic layers 32, 42 each include a dispersion of magnetic pigments, an abrasive or head cleaning agent, a binder system, one or more lubricants, a conventional surfactant or wetting agent, and/or one or more solvents. In one embodiment, the magnetic layer 32 differs in composition and/or application as compared to the magnetic recording layer 42. In an alternative and preferred embodiment, the magnetic layers 32, 42 are similar in composition and/or application so as to form the magnetic sides 14, 16 with similar modulus values to limit cupping of the magnetic recording tape 10 to between about 100 μm and about −100 μm.

The magnetic pigments of each magnetic layer 32, 42 have a composition including, but not limited to, metallic iron and/or alloys of iron with cobalt and/or nickel, and magnetic or non-magnetic oxides of iron, other elements, or mixtures thereof, which will hereinafter be referred to as metal particles. Alternatively, the metal particles can be composed of hexagonal ferrites such as barium ferrites. In order to improve the required characteristics, the preferred magnetic pigments may contain various additives, such as semi-metal or non-metal elements and their salts or oxides, such as Al, Co, Y, Ca, Mg, Mn, Na, and other suitable additives. The selected magnetic pigment may be treated with various auxiliary agents before it is dispersed in the binder system.

The head cleaning agent may be added to the magnetic layer dispersions separately or may be dispersed within a binder system prior to addition to the magnetic layer dispersions. In one embodiment, the head cleaning agent is aluminum oxide. Other abrasive grains, such as silica, ZrO₂, CrO₃, etc., can also be employed either alone or in mixtures with aluminum oxide or each other to form the head cleaning agent.

In one embodiment, the binder system of one or both of the magnetic layers 32, 42 incorporates at least one binder resin, such as a thermoplastic resin, in conjunction with other resin components, such as binders and surfactants used to disperse the head cleaning agent, a surfactant or wetting agent, and one or more hardeners. In one embodiment, the binder system includes a combination of a primary polyurethane resin and a vinyl resin. Examples of polyurethanes include polyester-polyurethane, polyether-polyurethane, polycarbonate-polyurethane, polyester-polycarbonate-polyurethane, and polycaprolactone-polyurethane. The vinyl resin is frequently a vinyl chloride resin, a vinyl chloride-vinyl acetate copolymer, vinyl chloride-vinyl acetate-vinyl alcohol copolymer, vinyl chloride-vinyl acetate-maleic anhydride and the like. Resins such as bis-phenyl-A epoxide, styrene-acrylonitrile, and nitrocellulose may also be acceptable in certain magnetic recording medium formulations. In an alternate embodiment, the vinyl resin is a non-halogenated vinyl copolymer. Useful vinyl copolymers include copolymers of monomers comprising (meth)acrylonitrile; a nonhalogenated, hydroxyl functional vinyl monomer; a nonhalogenated vinyl monomer bearing a dispersing group, and one or more nonhalogenated nondispersing vinyl monomers.

In one example, the binder system further includes a head cleaning agent binder used to disperse the selected head cleaning agent material, such as a polyurethane binder in conjunction with a pre-dispersed or paste head cleaning agent. Use of other head cleaning agent binders compatible with the format of the selected head cleaning agent (e.g., powder head cleaning agent) is also contemplated.

In one embodiment, the magnetic layers 32, 42 each include one or more lubricants such as a fatty acid and/or a fatty acid ester. The incorporated lubricant(s) exist throughout the magnetic sides 14, 16 including at the recording surfaces 36, 46 of the magnetic layers 32, 42. In general, the lubricant(s) reduce friction to maintain smooth contact with low drag and at least partially protects the recording surfaces 36, 46 from wear. Thus, in one embodiment, the lubricant(s) provided in both the magnetic layers 32, 42 and the support layers 30, 40 are selected and formulated in combination.

The conventional surfactant or wetting agent may be added separately to a magnetic layer dispersion including one or more of the above-identified components or added to the binder system prior to being added to the magnetic layer dispersion. In one embodiment, suitable surfactants, such as phenylphosphonic acid (PPA), 4-nitrobenzoic acid, and various other adducts of sulfuric, sulfonic, phosphoric, phosphonic, and carboxylic acids are utilized. In one embodiment, the binder system contains a hardening agent such as isocyanate or polyisocyanate.

The materials for one or both of the magnetic layers 32, 42 are mixed together to form the magnetic layer dispersion. The magnetic layer dispersion is coated onto the respective surface 34 or 44 of the support layer 30 or 40 to form the magnetic layer 32 or 42. In one embodiment, solvents are added to the magnetic layer dispersion prior to coating the support layer 30 with the magnetic layer 32 or 42.

In one embodiment, the coated and processed magnetic layers 32, 42 each have a final thickness from about 2 microinches (0.05 μm) to about 10 microinches (0.25 μm), preferably from about 2 microinches to about 5 microinches (0.125 μm). In one embodiment, at least one of the magnetic layers 32 and/or 42 is formed over a respective support layer 30, 40 and compressed so as to define a resistivity of a corresponding magnetic side 14 and/or 16 less than 2×10⁶ ohms/square so as to decrease static build-up and the attraction of unwanted debris to the magnetic recording tape 10 during use. In one embodiment, the coating layer 14, 16 is formed to define a resistivity of less than 5×10⁵ ohms/square. In some embodiments, the level of resistivity described above is below the permissible ranges for conventional magnetic recording tapes conforming to standardized formats, such as LTO tapes.

Manufacturing Systems and Processes

For manufacturing, the components of each of the support layers 30, 40 are combined in a manner described above to form coatings corresponding to each of the support layers 30, 40 and configured to be applied to the substrate 12. In one embodiment, the coating for the support layer 30 is similar or substantially identical to the coating for the support layer 40. In other embodiments, the coatings of the support layers 30 and 40 differ from each other. Similarly, each of the magnetic layers 32, 42 are also mixed to form the respective coating mixtures, which are subsequently coated on the respective support layers 30, 40. In one embodiment, the coatings of the magnetic layers 32, 42 are similar or substantially identical so as to contribute to the formation of the dual magnetic sides 14, 16 each having a similar modulus to, thereby, form the magnetic recording tape 10 to exhibit cupping between about 100 μm and about −100 μm. In other embodiments, the coating of the magnetic layers 32, 42 differ from each other.

In one embodiment, the coating materials of the support layers 30, 40 and magnetic layers 32, 42 are prepared by dispersing the corresponding powders or pigments and the binders in a solvent. For example, with respect to one embodiment of the coating material for the magnetic layer(s) 32 and/or 42, the primary metal particle powder or pigment and the large particle carbon materials are placed in a high solids mixing device along with certain of the resins (e.g., polyurethane binder, vinyl chloride binder, and surfactant) and the solvent and processed for 1-4 hours. The resulting material is processed in a high-speed impellor dissolver for approximately 30-90 minutes, along with additional amounts of the solvent. Following this let down processing, the resulting composition is subjected to a sand milling or polishing operation. Subsequently, the HCA and related binder components (where necessary) are added, and the composition is left standing for approximately 30-90 minutes. Following this let down procedure, the composition is processed through a filtering operation, and then stored in a mixing tank after which time the hardener component and lubricants are added. The resulting magnetic layer coating material is then ready for coating. Other methods of preparing the magnetic layer coating materials are also contemplated.

Preparation of the support layer(s) 30 and/or 40 coating material preferably entails a similar process, including high solids mixing of the primary lower layer pigment, the conductive carbon black material, and the binder resins in a solvent for approximately 2-4 hours. Similar sandmilling and hardener and/or lubricant additions occur as described above with respect to the magnetic layers 32, 42 coating material.

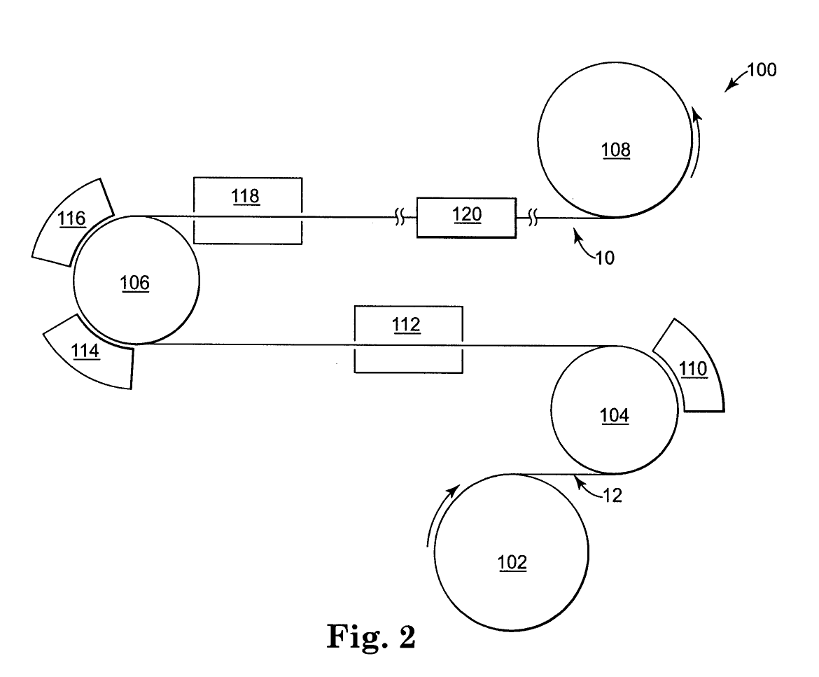

Following preparation, the various coating materials are applied over the substrate 12. In one example, the various coating materials are applied in an on-line manufacturing system generally illustrated at 100 in FIG. 2. In one embodiment, manufacturing system 100 includes a supply roll 102, guide rolls 104, 106, and a take-up roll 108. The magnetic recording tape 10, or at least a portion thereof, moves from supply roll 102 over guide rolls 104, 106 to take-up roll 108 in a defined media path. Various components for coating and drying materials on the substrate 12 are located along the media path.

In one embodiment, the manufacturing system 100 includes a coating or deposition station 110, a dryer 112, coating or deposition stations 114, 116, and a dryer 118. The first coating station 110 is configured to apply at least a portion of the first support layer 30 to the substrate 12. The coating station 110 is preferably positioned relatively close to the supply roll 102 to decrease the exposure of a bare or merely primed substrate 12 to the environment within the manufacturing system 100. As such, static build up and debris attraction during manufacturing is further decreased contributing toward more reliable resultant magnetic recording tapes.

The first coating station 110 applies a portion 30a of the coating material for a first support layer 30 using any suitable coating technique. In one example, a about 10% to about 50% of the thickness of the support layer 30 is included in the first portion 30a. In alternative embodiments, the entire first support layer is applied to the substrate 12 at the first coating station 110. Following coating of the substrate with the first portion 30a of the support layer 30, the substrate 12 continues along the media path through or past the dryer 112. The dryer 112 is configured to dry the coating materials applied by the first coating station 110, thereby, securing the coating materials of the first portion 30a of the first support layer 30 to the substrate 12. Following drying, the substrate 12 continues along media path to the coating stations 114, 116.

In one embodiment, the second coating station 114 is configured to apply coating materials of the second support layer 40, and the third coating station 116 is configured to supply the coating materials of the second magnetic layer 42 in any suitable coating technique. In one embodiment, the magnetic layer 42 is coated over the support layer 40 in a wet-on-wet processing technique. As such, in one embodiment, the coating systems 114, 116 are spaced less than about 6 inches apart to prevent drying of the support layer 40 prior to coating of the magnetic layer 32 over the substrate 12. In one embodiment, the wet-on-wet processing technique promotes adhesion of the magnetic layer 42 to the support layer 40.

Following deposition of second support layer 40 and the second magnetic layer 42, the substrate 12 continues along the media path through or by the dryer 118, which is similar to the dryer 112, described above. The dryer 118 is configured to dry both the support layer 40 and the magnetic layer 42 therefore affixing the layers 40, 42 to the substrate 12.

In one embodiment, following drying at drying station 118, the coated substrate 12 proceeds to the in-line calendering station 120. According to one embodiment, manufacturing of the magnetic recording tape 10 includes compliant-on-steel (COS), in-line calendering at station 120. COS in-line calendering uses one or more in-line nip locations, in each of which a steel or other generally non-compliant roller contacts or otherwise is applied to the recording surface 46 and a rubberized or other generally compliant roll contacts or otherwise is applied to the opposing surface of the partially coated substrate 12. The generally non-compliant roll is applied to provide a desired degree of smoothness to the magnetic recording tape 10. In one embodiment, calendering further includes heating the rollers contacting the magnetic recording tape 10.

Alternatively or additionally, the in-line calendering station 120 includes “steel-on-steel” (SOS) calendering in which both opposing rolls are steel. The process may also employ one or more nip locations each having generally non-compliant rolls. After in-line calendering, the coated substrate 12 is wound on the take-up roll 108. In an alternate embodiment, the substrate 12 may continue directly from dryer 118 to take-up roll 108. The take-up roll 108 collects the coated substrate 12 for further processing.

In one embodiment, the material from the take-up roll 108 is removed from the take-up roll 108 and is re-positioned on the supply roll 102 to be once again processed through the manufacturing system 100. This time, nothing is applied at coating station 110, however, at coating station 114, any remaining portion 30b of the support layer 30 is coated onto the first portion 30a of the support layer 30 initially deposited in the first pass through the manufacturing system 100. In this manner, the second portion 30b of the support layer 30 is applied to the first portion 30a of the support layer 30 in a wet-on-dry process.

Following deposition of the second portion 30b of the support layer 30, the coating materials of the magnetic layer 32 are applied over the second portion 30b of the support layer 30 in a wet-on-wet technique to promote adhesion of the magnetic layer 32 to the support layer 30. However, in an alternative embodiment, the entirety of the support layer 30 is initially applied in the first pass through the manufacturing system 100. In such an embodiment, the magnetic layer 32 is applied at the coating station 116 over the substantially dry support layer 30. As such, a wet-on-dry technique is utilized.

The substrate 12, now coated with dual sides 14, 16, is passed through dryer 118 and/or calendering stations 120 before being wound upon the take-up roll 108. In other embodiments, additional coating stations may be positioned between the dryer 118 and the take-up roll 108 to apply the second magnetic side 16 without requiring additional passage through the manufacturing system 100. Other alterations in the manufacturing system 100 are also contemplated.

Following processing through the manufacturing system 100, in one embodiment, the process proceeds to an off-line portion, which occurs at a dedicated stand-alone machine. During off-line calendering, the magnetic recording tape 10 is unwound and calendered. The off-line calendering includes passing the magnetic recording tape 10 through a series of generally non-compliant rollers, e.g., multiple steel rollers, although other materials other than steel may be used to form the rollers. The magnetic recording tape 10 is then wound a second time. The wound roll of the magnetic recording tape 10 is then slit, burnished, and tested for defects.

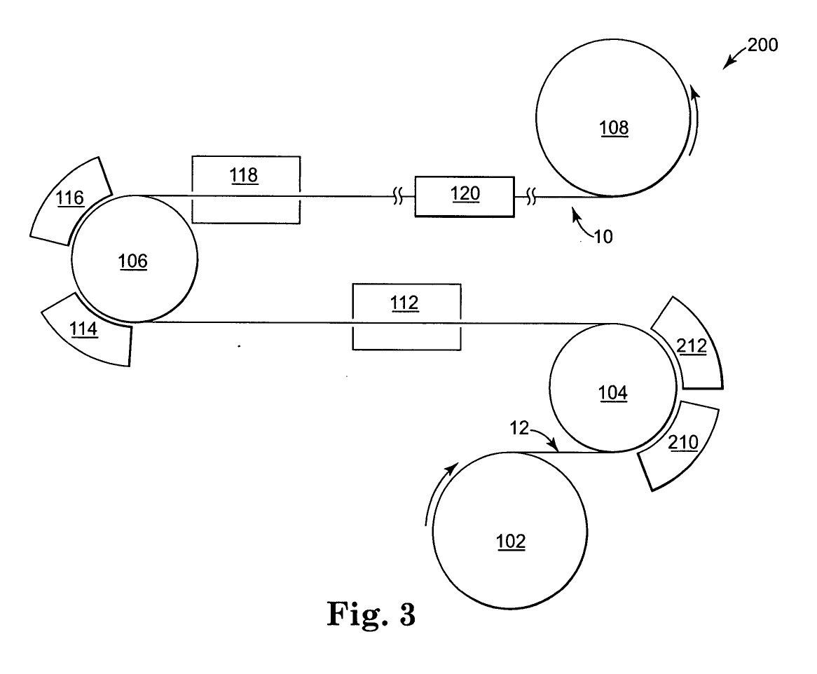

Another embodiment of a manufacturing system is generally indicated in FIG. 3 at 200. The manufacturing system 200 is similar in many respects to manufacturing system 100, as indicated by similar reference numerals indicating similar or identical parts. However, rather than a single coating station 110 (FIG. 2), two coating stations, 210, 212, are positioned relatively near the supply roll 102. The coating station 210 is configured to coat the support layer 30 in a similar manner as the coating station 114 is configured to apply the support layer 40 as described above. Similarly, the coating station 212 is configured to apply the magnetic layer 32 in a similar manner as the coating station 116 is configured to apply the magnetic layer 42 as described above. Accordingly, in one embodiment, the coating station 210 and the coating station 212 are positioned relatively near each other, such as, less than 6 inches apart from one another, so as to promote wet-on-wet adhesion of the magnetic layer 32 to the support layer 30.

Following coating the substrate 12 with the first support layer 30 and the first magnetic layer 32, the partially coated substrate continues in to the coating stations 114, 116 to be coated with the second support layer 40 and the second magnetic layer 42 in a similar manner as described above with respect to the manufacturing system 100. In this respect, the first magnetic side 14 is applied to the substrate 12 at the coating stations 210, 212, and the second magnetic side 16 is applied to the substrate 12 at the coating stations 114, 116. The magnetic recording tape 10 is dried at the dryer 118 and optionally calendered at 120, in a similar manner as described above with respect to manufacturing system 100. In this manner, a second pass of the magnetic recording tape 10 through the manufacturing system is not required since the entire magnetic recording tape 10 is formed in a single pass through the manufacturing system 200. However, once wound upon take-up roll 108, the magnetic recording medium 10 may further be processed offline in a similar manner as described above.

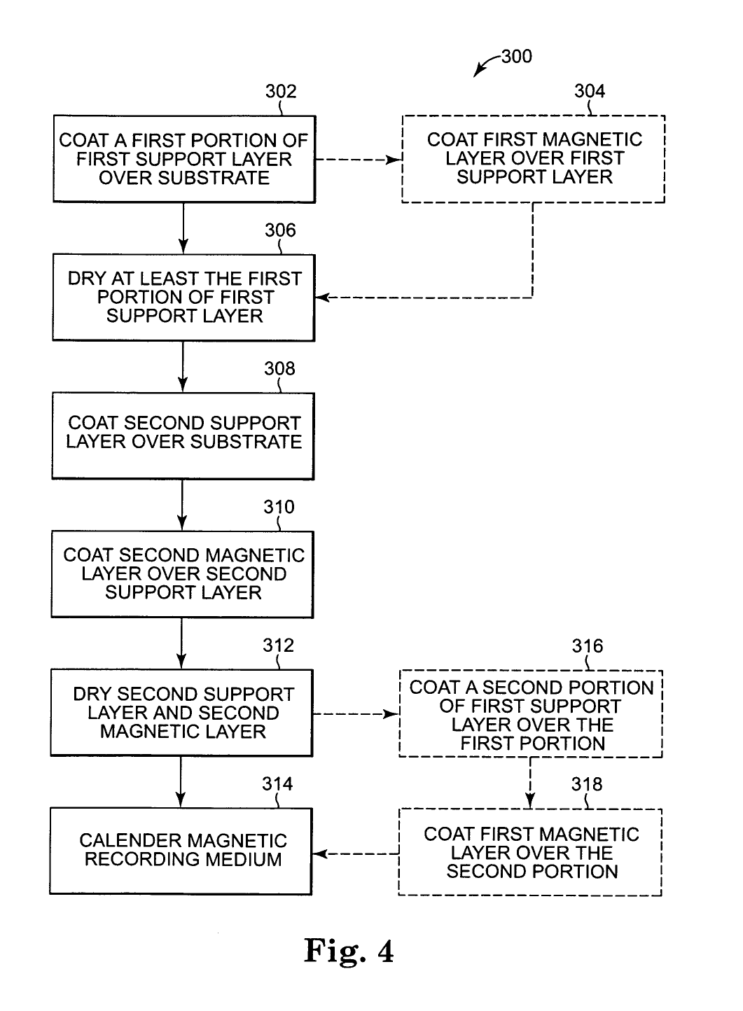

FIG. 4 is a flow chart illustrating one embodiment of a method of manufacturing a magnetic recording tape generally at 300 and described with additional reference to FIG. 1. At 302, a first portion 30a of the first support layer 30 is applied over the substrate 12, where the substrate 12 may be bare or may be coated with the primer 22. The first portion 30a can be any portion equal to or less than an entirety of the support layer 30. In one embodiment, where the first portion 30a is the entirety of the support layer 30, at 304, the first magnetic layer 32 is coated over the first support layer 30 (for example, in a similar manner as described with respect to manufacturing system 200). After coating the magnetic layer at 304, the method 300 continues to operation 306. However, where the first portion 30a is less than the entirety of the first support layer 30 (for example, as described with respect to manufacturing system 100), in one embodiment, the method 300 continues directly to operation 306 without coating the first magnetic layer at 304.

At 306, the first portion 30a is dried over the substrate 12 by passing the partially coated substrate 12 through a dryer. At 308, the second support layer 40 is coated over the bottom surface 20 of the substrate 12, where the bottom surface 20 of the substrate 12 is either bare or previously coated with the primer 24. For example, the second support layer 40 is coated at 308 in a similar manner as described above with respect to the coating station 114.

At 310, the second magnetic layer 42 is coated over the second support layer 40. In one example, the second magnetic layer 42 is coated in a manner similar to that described above with respect to the coating station 116. In one embodiment, the second magnetic layer 42 is coated over the second support layer 40 using a wet-on-wet processing technique. After the second support layer 40 and the second magnetic layer 42 are coated, then at 312, the layers 40, 42 are substantially simultaneously dried by passing the magnetic recording medium 10 through or by a dryer.

In one embodiment, where the first magnetic layer 32 was previously applied at 302, then the magnetic recording medium 10 is calendered at 314 in any suitable manner, such as the manners described above. Conversely, wherein operation 304 was not performed above, then following operation 312, a second portion 30b of the first support layer 30 is coated over the first portion 30a at operation 316 (for example, in a similar manner as described above with respect to system 100). In one embodiment, the second portion 30b is coated over the first portion 30a using a wet-on-dry processing technique.

Then at 318, the first magnetic layer 32 is coated over the second portion 30b of the first support layer 30 (for example, in a similar manner as described above with respect to system 100). In one embodiment, the first magnetic layer 32 is coated over the support layer 30, more particularly, over the second portion 30b, using a wet-on-wet processing technique to encourage adhesion and bonding between the magnetic layer 30 and the support layer 32. Once the magnetic layer 32 is applied at 318, the magnetic recording medium 10 is calendered at 314 as described above. In one embodiment, the composition of the layers and the calendering techniques as described above contribute to producing a magnetic recording medium in method 300 that includes at least one magnetic recording side having a relatively low resistivity, preferably a resistivity less than 5×10¹⁰ ohms/square, more preferably a resistivity less than 2×10⁶ ohms/square, and even more preferably, a resistivity less than 5×10⁵ ohms/square. The dispersion used to form the support layer 30, 40 is milled for at least about eight hours, more preferably, for at least about 12 hours, even more preferably for at least about 18 hours.

The embodiments of the magnetic recording media described above are configured to provide a magnetic recording medium having dual magnetic recording sides to increase the capacity of the magnetic recording tape to more than 500 GB or more preferably, more than 800 GB. Not only is the capacity of the magnetic recording media of the embodiments described herein relatively high, but the magnetic sides of the magnetic recording medium are specifically configured to provide at least one of the magnetic sides having a resistivity of less than about 2×10⁶ ohms/square, preferably less than about 5×10⁵ ohms/square. In this manner, static build up and the amount of undesired debris attracted to the magnetic recording medium during use is decreased. Therefore, the magnetic recording media resulting from the embodiments of the present invention have increased reliability and longer lifespan than conventional magnetic recording media having dual magnetic sides.

In addition, due to particular design considerations in forming the first magnetic side 14 relative to the second magnetic side 16, the two magnetic sides may be formed to each have a similar modulus, such that cupping of the magnetic recording media is exhibited at between about 100 μm and about −100 μm. Accordingly, since the level of cupping is maintained at a relatively low level, handling during manufacture and subsequent use is increased, therefore further contributing to the reliability and lifespan of the resulting magnetic recording media.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

### EXAMPLES

As described above, various formulations of magnetic recording media fall within the scope of the present invention. One specific example of a magnetic recording medium, more specifically, a magnetic recording tape, formed in accordance with the present invention is described in detail below. Three comparative examples of magnetic recording tapes are also described in detail below.

### Example 1

In accordance with the present invention, Example 1 is formed with a thin PEN substrate, a first magnetic side, and a second magnetic side. The first and second magnetic sides are substantially identical to one another and each include a support layer and a magnetic layer. The support layers each include a primary pigment, a surfactant, carbon black, a head cleaning agent (HCA), binders, lubricants, and an activator mixed with parts per hundred of the primary pigment as shown in Table 1 below.

More specifically, support layer includes a primary pigment of DB-65 (available from Toda Kogyo Corp. of Hiroshima, Japan). The surfactant is Phenylphosphinic Acid included at 1.5 pph, the carbon black is Ketjenblack EC-600JD (available from Akzo Nobel of the Netherlands) included at 6.0 pph, and the HCA is HIT60A (available from Sumitomo Chemical Co. of Japan) included at 5.75 pph. In addition, the binders are UR4125 (available from Toyobo of Japan) included at 7.21 pph and MR-104 (available from Nippon Zeon Co. Ltd. of Tokyo, Japan) included at 11.07 pph, the lubricants are butyl stearate included at 1 pph and stearic acid included at 2.5 pph, and the activator is a 55 wt % solution of polyisocyanate in methylethylketone (for example, Mondur.RTM. CB55N available from the Bayer Corporation of Pittsburgh, Pa.) included at 3.6 pph, wherein the pph values provided express parts per hundred by weight based on the primary pigment in the support layer.

The magnetic layers are each coated onto the corresponding support layers in a wet-on-wet processing technique. The magnetic layer includes a primary pigment of NF-406 (available from Toda Kogyo Corp.) included at 100 pph, a surfactant of Phenylphosphinic Acid included at 3.0 pph, carbon blacks of Sevacarb MT included at 0.5 pph and Raven 410 included at 0.5 pph (both available from Columbian Chemical of Marietta, Ga.). In addition, the magnetic layer includes an HCA of HIT60A (available from Sumitomo Chemical Co., Japan) at 8.0 pph, binders of UR4125 (available from Toyobo, Japan) at 6.33 pph and MR-104 (available from Nippon Zeon Co. Ltd.) at 14.85 pph, lubricants of butyl palmitate included at 1 pph and stearic acid included at 1 pph, and an activator of a 55 wt % solution of polyisocyanate in methylethylketone (Mondur.RTM. CB55N, Bayer Corporation, Pittsburgh, Pa.) included at 3.47 pph. The above pph values for the magnetic layer components are expressed as part per hundred parts by weight based on the primary pigment in the magnetic layers.

The above-recited formulations for the support and magnetic layers are prepared and applied to substrate in a wet-on-wet process. Following manufacturing, which includes milling for 12 hours, as indicated in Table 2, the magnetic recording medium is calendered at a temperature between 125° F. and 200° F. at a pressure range of between 600 pli and 3000 pli. After calendering, the magnetic recording medium is slit to form magnetic recording tape.

Based upon test results for similar magnetic recording tapes having a single magnetic side, the magnetic recording tape is expected to have a resistivity at each magnetic side of about 4.20×10⁵ ohms/square, as indicated in Table 2.

TABLE 1
Support Layer Composition

| | Values Expressed in Parts Per Hundred by Weight of Primary Pigment | | | | | | |
|---|---|---|---|---|---|---|---|
| Example | Primary Pigment | Surfactant | Carbon Black | HCA | Binders | Lubricants | Activator |
| 1 | 100 | 1.5 | 6 | 5.75 | 19.03 | 3.5 | 3.6 |
| C1 | 100 | 1.5 | 4 | 5.75 | 18.94 | 3.5 | 3.6 |
| C2 | 100 | 1.5 | 5 | 5.75 | 19.38 | 3.6 | 3.6 |
| C3 | 100 | 1.5 | 4 | 5.75 | 18.94 | 3.5 | 3.6 |

TABLE 2
Milling Time and Expected Resistivity

| Example | Mill Time (hours) | Expected Resistivity (ohms/sq.) |
|---|---|---|
| 1 | 12 | 4.20 × 10⁵ |
| C1 | 12 | 8.67 × 10⁸ |
| C2 | 12 | 5.30 × 10⁶ |
| C3 | 8 | 2.32 × 10⁷ |

### Comparative Examples 1-3

Comparative Examples 1-3 (shown in the above tables as Examples C1-C3) are formed using similar formulations and processing conditions to those described above with respect to Example 1. However, the support layer is formed with differing carbon black and binder levels as indicated in Table 1 above. In addition, while Example 1 was processed with a milling time of 12 hours, Comparative Example 3 was processed with a milling time of 8 hours as indicated in Table 2. Table 2 also indicates that the resulting magnetic sides of each of the Comparative Examples 1-3 exhibit higher resistivity values as compared with the magnetic recording medium of Example 1.

What is claimed is:

1. A magnetic recording medium for storing digital data, the magnetic recording medium comprising:
a flexible substrate defining a first surface and a second surface opposite the first surface;
a first magnetic side having a resistivity of less than about 2×10⁶ ohms/square and including:
a first support layer being substantially non-magnetic and extending over the first surface of the substrate, and
a first magnetic recording layer extending over the first support layer opposite the substrate; and
a second magnetic side including:
a second support layer being substantially non-magnetic and extending over the second surface of the substrate, and
a second magnetic recording layer extending over the second support layer opposite the substrate.

2. The magnetic recording medium of claim 1, wherein the second magnetic side has a resistivity of less than about 2×10⁶ ohms/square.

3. The magnetic recording medium of claim 1, wherein the first support layer includes primary pigment particles and at least about 5.5 parts of carbon black per 100 parts of the primary pigment particles.

4. The magnetic recording medium of claim 3, wherein the carbon black has a mean size of about 1400 m²/g.

5. The magnetic recording medium of claim 3, wherein the second support layer includes primary pigment particles and at least about 5.5 parts of carbon black per 100 parts of the primary pigment particles of the second support layer.

6. The magnetic recording medium of claim 1, the first magnetic side defines a first modulus similar to a second modulus defined by the second magnetic side to form the magnetic recording medium to exhibit cupping between about −100 μm and about 100 μm.

7. The magnetic recording medium of claim 1, wherein a primer is applied directly to each of the first surface and the second surface of the substrate.

8. The magnetic recording medium of claim 1, wherein the magnetic recording medium has a capacity of at least 500 GB.

9. The magnetic recording medium of claim 1, wherein the magnetic recording medium is a magnetic recording tape.

10. A method of manufacturing a magnetic recording medium for storing data, the method comprising:
coating a portion of a first support layer over a first surface of a flexible substrate, the first support layer being substantially non-magnetic;
coating a first magnetic recording layer over the first support layer to form a first magnetic side including the first support layer and the first magnetic layer;
coating the second support layer over a second surface of the flexible substrate opposite the first surface, the second support layer being substantially non-magnetic;
coating a second magnetic recording layer over the second support layer to form a second magnetic side including the second support layer and the second magnetic layer; and
calendering the magnetic recording medium;
wherein at least one of the first magnetic side and the second magnetic side are formed to have a resistivity of less than about 2×10⁶ ohms/square.

11. The method of claim 10, wherein the portion of the first support layer is a first portion, the method further comprising:
drying the first portion of the first support layer; and
coating a second portion of the first support layer over the first portion of the first support layer after drying the first portion;
wherein coating the first magnetic recording layer over the first support layer occurs after coating the second portion of the first support layer.

12. The method of claim 11, wherein the first magnetic recording layer is coated on the second portion of the first support layer in a wet-on-wet process.

13. The method of claim 10, wherein the first support layer includes at least 5.5 parts of carbon black per 100 parts per unit weight of primary pigment particles.

14. The method of claim 13, wherein the second support layer includes at least 5.5 parts of carbon black per 100 parts per unit weight of primary pigment particles.

15. The method of claim 10, wherein manufacturing the magnetic recording medium includes milling the magnetic recording medium for more than about 8 hours.

16. The method of claim 10, wherein both the first magnetic side and the second magnetic side have a resistivity of less than about 2×10⁶ ohms/square.

17. The method of claim 10, wherein the portion of the first support layer is about 10% to about 50% of the first support layer.

18. The method of claim 10, wherein the portion of the first support layer is an entirety of the first support layer.

19. The method of claim 18, wherein the first magnetic recording layer is deposited on the first support layer in a wet-on-wet process.

20. The method of claim 10, wherein the magnetic layer is a particulate magnetic layer including a magnetic particulate material dispersed in a binder system.
